(19) United States
(12) Patent Application Publication
(10) Pub. No.: US 2026/0029553 A1
(43) Pub. Date: Jan. 29, 2026

(54) SYSTEM AND METHOD FOR SEISMIC IMAGING USING HYBRID L1/L2 TRAVELTIME DIFFERENCE BASED FULL WAVEFORM INVERSION

(71) Applicant: CHINA PETROLEUM & CHEMICAL CORPORATION, Beijing (CN)

(72) Inventors: Xuejian LIU, Houston, TX (US); Bin YU, Houston, TX (US)

(21) Appl. No.: 18/785,214

(22) Filed: Jul. 26, 2024

(51) Int. Cl. G01V 1/50

(52) U.S. Cl. CPC G01V 1/50; G01V 2210/614; G01V 2210/6222; G01V 2210/66; G01V 2210/67

(57) ABSTRACT

Method and apparatus for constructing seismic velocity models of the underground geologic formation using full waveform inversion are provided. The method evaluates velocity model accuracy by measuring local traveltime differences between recorded seismic data and synthetic data. The travetime misfit may be calculated with a hybrid L1/L2 norm that relatively lowers down the influence of large traveltime difference in each iteration and ensures the inversion stability. The method tolerates poor quality initial model and generates high resolution models.

### TECHNICAL FIELD

The disclosure generally relates to method and device of full waveform inversion (FWI) that invert high-resolution subsurface propagation velocity model using seismic data, specifically using hybrid L1/L2 traveltime difference based FWI.

### BACKGROUND OF INVENTION

### 1. Overview

Seismic data are seismic waves emitted by seismic sources (such as dynamite source, sledgehammer hitting, vibrator, earthquake, etc.), travel through subsurface underground, and recorded by the sensors/receivers installed on the earth surface/interior. The recorded seismic data contain digital signals along elapsed time which reflect subsurface geological information of layer, fault, anticline, etc. Similar to computerized tomography (CT) that inverts a series of X-ray for images of human body, seismic processing uses seismic data to obtain images of the Earth's subsurface.

Mathematical methods can invert these seismic data to be an image of these subsurface structures. More specifically, the term “image” denotes grids of pixel values of subsurface geophysical attributes. The most frequently used attribute is seismic wave propagation velocity of subsurface, which helps to identify the location and interfaces among different materials. While the image may not provide an accurate location for natural resources, such as oil and gas, geothermal, mineral, coal, etc., it enables those trained geophysicists to determine possible prospecting targets through interpretations and to inform the exploration/drilling plan. However, due to the high cost of well drilling, obtaining higher-resolution images for more accurate natural-source-location interpretation is of great import.

One way to produce high resolution subsurface models is via full waveform inversion (FWI) of recorded seismic data. FWI is a seismic data processing technique that iteratively updates the propagation velocity model to minimize the difference between synthetic data generated using the current model and recorded seismic data, which is a promising data-driven tool to automatically produce high-resolution velocity models. FWI was computationally cost prohibitive for industrial production. Efficient methods with compromised accuracy such as seismic tomography were used to build velocity models. However, for complex geologic environments, e.g., subsalt area and overthrust belts, seismic tomography is not effective.

More recently, fast-growing computer resources as well as advanced FWI techniques has made FWI more practical and led to significant improvements on imaging complex geological area. In the past, least-squares waveform difference was often used as the objective function, which faces technical issues of cycle skipping and amplitude-discrepancy that plagued the FWI industrial applications. The oscillatory nature of seismic signals causes the cycle-skipping problem, which, when neither low frequency components nor a good initial model is available, FWI attempts to match synthetic data to recorded data at a wrong cycle and invert erroneous velocity models. On the other hand, the mathematical modeling method of synthetic data cannot repeat the real propagation procedure of recorded data involved complex physics, thus resulting in amplitude discrepancies and wrong velocity inversion. To overcome these issues, recent FWI development focuses on least squares traveltime difference (aka traveltime misfit) between the synthetic data and the recorded data and promote successful FWI applications on salt model building using marine data.

However, the traveltime difference picking may be not correct due to crosstalk noise among multiple seismic events, which is more pronounced when the traveltime difference is large at the inversion starting with a low quality initial model. New algorithms are needed to improve the traveltime difference based FWI, making FWI more stable to properly handle large traveltime differences.

### SUMMARY OF THE INVENTION

In one of the embodiments in this disclosure, a method for performing a seismic full waveform inversion to generate a velocity model of subsurface formations of a survey region, including multiple steps, including: positioning seismic data recording sensors in the survey region at different locations and/or positioning a well logging tool including seismic data recording sensors in a well bore in the survey region; emitting at points of incidence in the survey region to generate seismic waves, which travel through subsurface earth formations; observing the seismic waves and recording seismic data based on the seismic waves using the seismic data recording sensors; transmitting the observed seismic data from the seismic data recording sensors to a computer system including one or more memories and storing the observed seismic data in one or more memories, storing a source wavelet and a current medium parameter model in the one or more memories; performing, by the computer system, a forward modeling operation using the source wavelet and a current medium parameter model to obtain synthetic data; processing, by the computer system, the synthetic data and the observed seismic data to obtain traveltime differences between them; building, by the computer system, the objective function of traveltime differences with the hybrid L1/L2 norm; solving, by the computer system, the related seismic adjoint sources; an adjoint equation of the forward wave-equation is solved using adjoint sources; forming, by the computer system, the inversion gradient and perturbation; calculating, by the computer system, analytical step length related to the hybrid L1/L2 traveltime objective function; generating, by the computer system, an updated medium parameter model; upon convergence, outputting the updated velocity as the final velocity model to a display of the computer system.

Also disclosed is a system for performing a seismic full waveform inversion to generate a velocity model of subsurface formations of a survey region. The system includes a plurality of seismic data recording sensors positioned in the survey region at different locations and/or a well logging tool including seismic data recording sensors positioned in a well bore in the survey region; a blasting device positioned at each point of incidence in the survey region to generate seismic waves, which travel through subsurface earth formations; and a plurality of seismic data recording sensors to sense seismic waves and record seismic data based on the seismic waves. The seismic data recording sensors transmit the seismic data to a computer system including one or more memories and at least one processor, the one or memories store the transmitted seismic data, a source wavelet, and instructions, and the one or more processors execute the instructions stored in the one or more memories to implement one of the methods disclosed in this disclosure.

### BRIEF DESCRIPTION OF THE DRAWINGS

The present invention can be readily understood by considering the following detailed description of the drawings.

FIG. 1 is a is a schematic diagram illustrating a top view of a survey region with the various points of incidence of seismic sources according to an embodiment in this disclosure.

FIG. 2 is a schematic diagram illustrating a cross-sectional view of an environment with points of incidence of seismic sources, seismic data recording sensors, a well location, a wellbore, the various transmission rays, and the various angles of incidence, according to an embodiment in this disclosure.

FIG. 3 is a schematic diagram illustrating a cross-sectional view of an environment with a wellbore and a well logging tool including one or more sonic generators and one or more well log data recording sensors according to an embodiment in this disclosure.

FIG. 4 is a schematic diagram illustrating a high-performance computing system according to an embodiment in this disclosure.

FIG. 5 is a flow diagram illustrating a FWI process using the least-squares (L2) objective function of traveltime differences.

FIG. 6 is a flow diagram illustrating a FWI process using the hybrid L1/L2 objective function of traveltime differences.

FIG. 7 shows the initial velocity model.

FIG. 8 shows the inverted velocity model obtained using the L2 traveltime difference based FWI method with bandpass filtered 2.5 Hz data and Is sliding local window.

FIG. 9 shows the inverted velocity model obtained using the proposed hybrid L1/L2 traveltime difference based FWI method with bandpass filtered 2.5 Hz data and 1 s sliding local window.

FIG. 10 shows the inverted velocity model obtained using the L1 traveltime difference based FWI method with bandpass filtered 2.5 Hz data and Is sliding local window.

FIG. 11 shows the convergence curves of three traveltime difference based FWI applications.

### DETAILED DESCRIPTION OF THE INVENTION

Reference will now be made in detail to several embodiments of the present disclosures, examples of which are illustrated in the accompanying figures. It is noted that wherever practicable similar or like reference numbers may be used in the figures and may indicate similar or like functionality. The figures depict embodiments of the present disclosure for purposes of illustration only. One skilled in the art will readily recognize from the following description that alternative embodiments of the structures, systems, and methods illustrated herein may be employed without departing from the principles of the disclosure described herein.

The present disclosure relates to building high resolution velocity models with an improved seismic full waveform inversion by applying methods, apparatuses, and mediums including a hybrid L1/L2 objective function of traveltime differences.

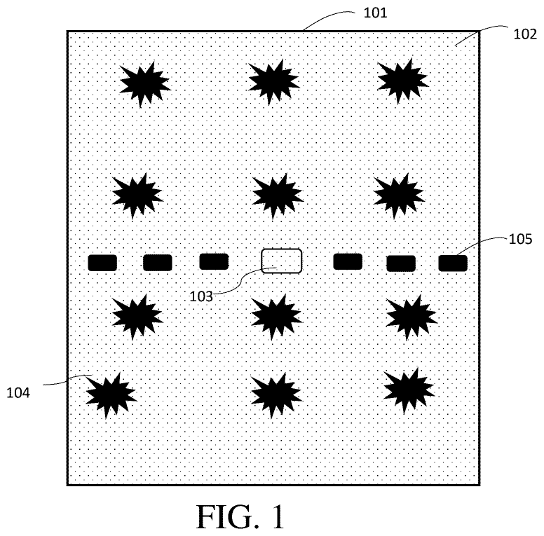

FIGS. 1-4 show exemplary embodiments of methods, apparatuses, and mediums for obtaining and storing the seismic data, which is processed to generate the one or more high resolution geological models for high resolution images for lithology identification, fluid discrimination, and reservoir characterization of complex subsurface structures of a survey region. The survey region may be subsurface structures under land or subsurface structures under the sea.

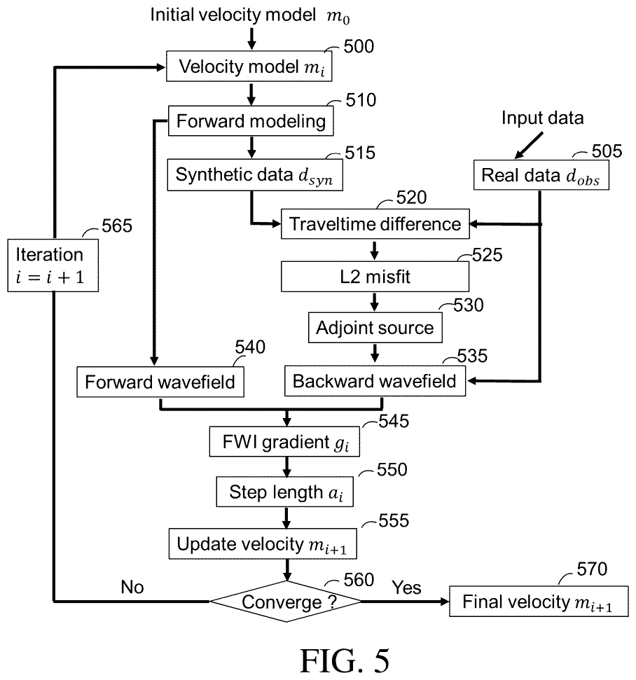

FIGS. 5-11 show exemplary embodiments of apparatuses, methods, and mediums to enhance the quality of seismic FWI results by using an improved seismic FWI technology to improve lithology identification, fluid discrimination, and reservoir characterization in the field of seismic exploration, including the use of a computer-implemented seismic FWI approach. FIGS. 5-11 show exemplary embodiments that generate inverted model parameters, which utilize different objective functions of traveltime differences, among which the hybrid L1/L2 objective function of traveltime differences based seismic FWI generate high resolution images of geological models of a survey region including complex subsurface structures. FIGS. 5-11 show exemplary embodiments that utilize the traveltime difference based FWI with the analytical step length calculation to generate one or more high resolution geological models for high resolution imaging for lithology identification, fluid discrimination, and reservoir characterization of complex subsurface structures of a survey region.

FIG. 1 is a schematic diagram illustrating a top view of a survey region with the various points of incidence of seismic sources according to an embodiment. More specifically, FIG. 1 illustrates a seismic survey region (survey region) 101, which is a land-based region denoted by reference numeral 102. Reference number 102 denotes the top earth formation of the land-based region 102. Persons of ordinary skill in the art, will recognize that seismic survey regions produce detailed images of local geology to determine the location and size of possible hydrocarbon (oil and gas) reservoirs, and therefore a well location 103. In these survey regions, seismic waves bounce off underground rock formations during emissions from one or more seismic sources at various points of incidence 104. A blast is an example of a seismic source generated by seismic equipment. The seismic waves that reflect back to the surface are captured by seismic data recording sensors 105, transmitted by one or more data transmission systems (frequently wirelessly) from the seismic data recording sensors 105, and stored for later processing and analysis by a high-performance computing system. Although this example shows a top earth formation of a land-based region 102, it is understood that this is only an example, and the methods and system may also be applied to a survey region at the bottom of an ocean.

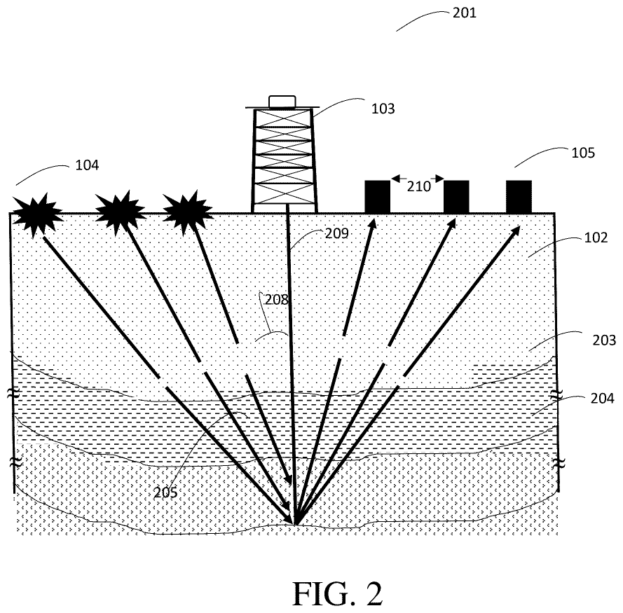

FIG. 2 is a schematic diagram illustrating a cross-sectional view of a seismic survey region 101 in FIG. 1 with points of incidence of seismic sources, seismic data recording sensors (seismic receivers), a well location, a wellbore, the various transmission rays, and the various angles of incidence, according to an embodiment. More specifically, in FIG. 2 a cross-sectional view of a portion of the earth over the seismic survey region denoted by reference numeral 201, showing different types of earth formations denoted by reference numerals 102, 203, and 204. Although the seismic survey region is based on land in this example, it is understood that the methods and system may also be applied to a survey region at the bottom of an ocean. FIG. 2 illustrates a common midpoint-style gather, where seismic data are sorted by surface geometry to approximate a single reflection point in the earth. The survey seismic data may also be referred to as traces, gathers, or image gathers. In this example in FIG. 2, data from one or more shots or blasts and receivers may be combined into a single image gather or used individually depending upon the type of analysis to be performed.

As shown on FIG. 2, one or more shots or blasts represent seismic sources located at various points of incidence or stations denoted by reference numeral 104 at the surface of the Earth at which one or more seismic sources are activated. Seismic energy or seismic sources from multiple points of incidence 104, are reflected from the interface between the different earth formations. These reflections are captured by multiple seismic data recording sensors 105, each of which is placed at different location offsets 210 from each other, and the well 103. Because all points of incidences 104, and all seismic data recording sensors 105 are placed at different offsets 210, the survey seismic data or traces, also known in the art as gathers or image gathers, is recorded at various angles of incidence represented by 208. The points of incidence 104 generate downward transmission rays 205, in the earth that are captured by their upward transmission reflection through the seismic data recording sensors 105. Well location 103, in this example, is illustrated with an existing drilled well attached to a wellbore, 209, along which multiple measurements are obtained using techniques known in the art. This wellbore 209, is used to obtain well log data, which may include P-wave velocity, S-wave velocity, density, among others. Other sensors, not depicted in FIG. 2, may be placed within the survey region to capture seismic data. Seismic data may be used to examine the dependence of amplitude, signal-to-noise, move-out, frequency content, phase, and other seismic attributes, on incidence angles 208, offset measurements 210, azimuth, and other geometric attributes that are important for data processing and imaging of a seismic survey region.

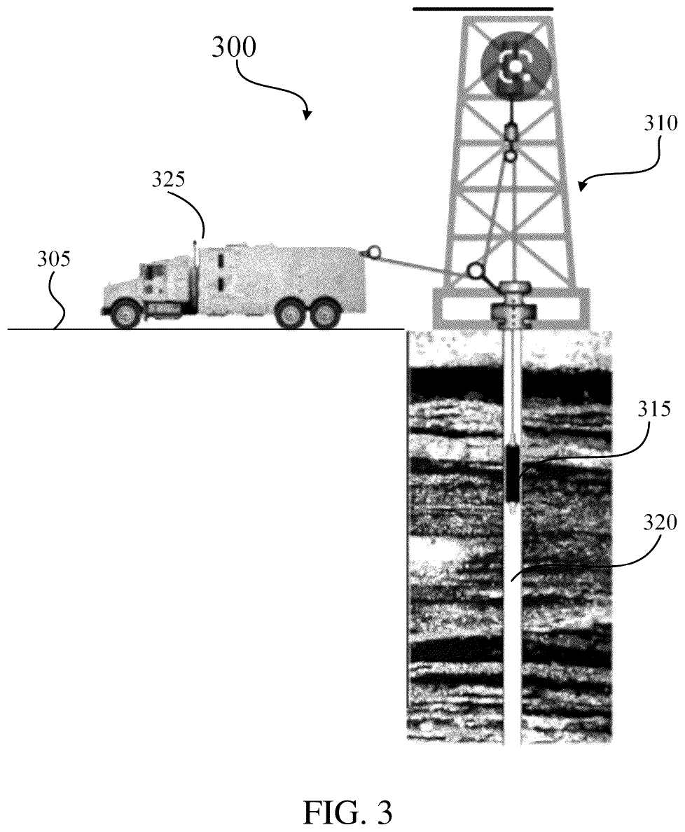

FIG. 3 is schematic diagram illustrating a cross-sectional view of a seismic survey region with a wellbore and well logging tool including one or more sonic generator and one or more well log data recording sensors according to an embodiment. A sonic generator is an example of equipment that produces one or more sonic waves (sound waves). A sonic generator may be referred to as a sonic source because the sonic generator produces or generates one or more sonic waves (sound waves), which are also referred to as seismic waves. The one or more well log data recording sensors are examples of one or more seismic data recording sensors (seismic receivers or seismic data recorders) and may be the same seismic data recording sensors as seismic data recording sensors 105. In embodiments of the present invention, oil and/or gas production is discontinued in order to generate seismic waves and record seismic data including reflections of the seismic waves moving through the subsurface of one or more earth formations in the seismic survey region.

FIG. 3 shows an oil drilling system 300 on land 305 that includes a drilling rig 310. The drilling rig 310 supports the lowering of a well logging tool 315 into a wellbore 320. The well logging tool 315 may include one or more sonic generators (sonic sources) to generate one or more sound waves, which are transmitted into one or more earth formations to generate reflections or reflection waves in the one or more earth formations. Although this example shows one or more earth formations of a land-based survey region, it is understood that this is only an example and that the methods and systems may also be applied to a survey region at the surface or bottom of a body of water such as an ocean. The well logging tool 315 also includes one or more well log data recording sensors. As discussed above, the one or more well log data recording sensors receive and record well log data, which includes reflection data received by the one or more well log data recording sensors in response to the sound waves transmitted into one or more earth formations by the one or more sonic generators. The well log data is an example of seismic data. The well log data may include compression wave velocity or P-wave velocity (Vp), shear wave velocity (Vs), and density, which is an indicator of porosity. This well logging process to record well log data may also be referred to as sonic logging. A vehicle 325 may be coupled to the well logging tool 315 to assist in the lowering and raising of the well logging tool 315 as well as communicating with the well logging tool 315 to obtain well log data. Alternatively, in methods and systems for a survey region at the surface or bottom of a body of water such as an ocean, another device or system may use to assist in the lowering or raising of the well logging tool 315 as well as communicating with the well logging tool 315 to obtain well log data.

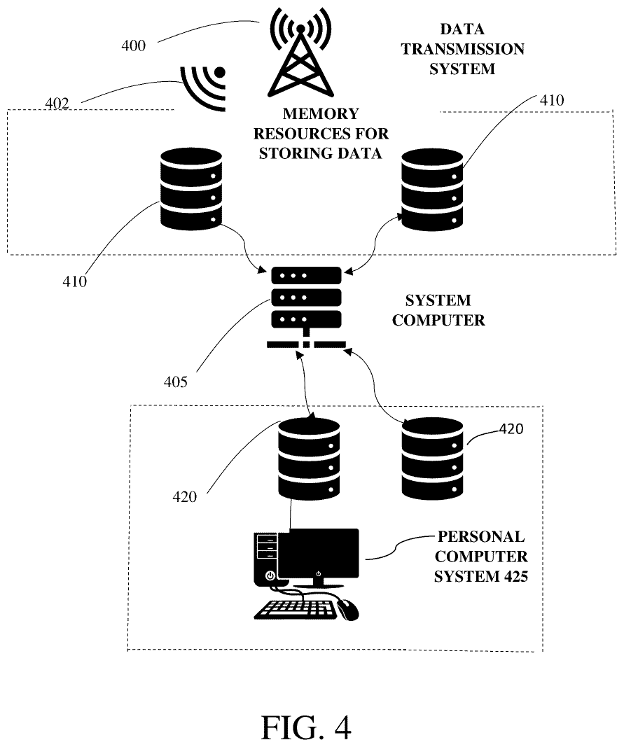

FIG. 4 is a schematic diagram illustrating a high-performance computer system according to an embodiment, which receives (through cable or wirelessly) seismic data regarding seismic waves from the seismic data recording sensors 105 in FIGS. 1 and 2 and/or the seismic data recording sensors in FIG. 3, which are also referred to as well log data recording sensors in FIG. 3. The high-performance computer system in FIG. 4 stores the seismic data in at least one memory for later processing and analysis by computer implemented methods and apparatuses of one or more embodiments. The analyzed or processed seismic data may be accessed by a personal computer system. More specifically, FIG. 4 shows a data transmission system 400 for wirelessly transmitting seismic data from seismic data recording sensors to a system computer 405 coupled to one or more storage devices 410 to store the seismic data in databases. The data transmission system may also transmit wirelessly seismic data from seismic data recording sensors 405 directly to one or more storage devices 410 to store the seismic data in databases, which may be accessed by system computer 405. The wireless transmission is denoted by reference numeral 402. The one or more storage devices 410 may also store other computer software instructions or programs to implement apparatuses and methods described in embodiments. The system computer 405 may be coupled (e.g., wirelessly coupled) to one or more output storage devices 420, which may receive the results of computer implemented processes or methods performed by the system computer 405. A personal computer 425 may be coupled (e.g., wirelessly coupled) to one or more output storage devices 420 and/or to the computer system 305 so that a user may utilize a user interface of the personal computer 425 to input information or obtain the results of the computer implemented processor methods performed by the system computer 405. The one or more storage devices 420 may also store other computer software instructions or programs to implement apparatuses and methods described in embodiments.

A user interface of the personal computer 425 may include, for example, one or more of a keyboard, a mouse, a joystick, a button, a switch, an electronic pen or stylus, a gesture recognition sensor (e.g., to recognize gestures of a user including movements of a body part), an input seismic device or voice recognition sensor (e.g., a microphone to receive a voice command), an output seismic device (e.g., a speaker), a track ball, a remote controller, a portable (e.g., a cellular or smart) phone, a tablet PC, a pedal or footswitch, a virtual-reality device, and so on. The user interface may further include a haptic device to provide haptic feedback to a user. The user interface may also include a touchscreen, for example. In addition, a personal computer 425 may be a desktop, a laptop, a tablet, a mobile phone or any other personal computing system.

Processes, functions, methods, and/or computer software instructions or programs in apparatuses and methods described in embodiments herein may be recorded, stored, or fixed in one or more non-transitory computer-readable media (computer readable storage (recording) media) that includes program instructions (computer readable instructions) to be implemented by a computer to cause one or more processors to execute (perform or implement) the program instructions. The media may also include, alone or in combination with the program instructions, data files, data structures, and the like. The media and program instructions may be those specially designed and constructed, or they may be of the kind well-known and available to those having skill in the computer software arts. Examples of non-transitory computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions may be executed by one or more processors. The described hardware devices may be configured to act as one or more software modules that are recorded, stored, or fixed in one or more non-transitory computer-readable media, in order to perform the operations and methods described above, or vice versa. In addition, a non-transitory computer-readable medium may be distributed among computer systems connected through a network and program instructions may be stored and executed in a decentralized manner. In addition, the computer-readable media may also be embodied in at least one application specific integrated circuit (ASIC) or Field Programmable Gate Array (FPGA).

The one or more databases may include a collection of data and supporting data structures which may be stored, for example, in the one or more storage devices 410 and 420. For example, the one or more storage devices 410 and 420 may be embodied in one or more non-transitory computer readable storage media, such as a nonvolatile memory device, such as a Read Only Memory (ROM), Programmable Read Only Memory (PROM), Erasable Programmable Read Only Memory (EPROM), and flash memory, a USB drive, a volatile memory device such as a Random Access Memory (RAM), a hard disk, floppy disks, a blue-ray disk, or optical media such as CD ROM discs and DVDs, or combinations thereof. However, examples of the storage devices 410 and 420 are not limited to the above description, and the storage may be realized by other various devices and structures as would be understood by those skilled in the art.

FIG. 5 is a flowchart illustrating the L2 traveltime difference based seismic full waveform inversion method according to an embodiment in this disclosure. The survey region may be subsurface structures under land or subsurface structures under the sea.

Referring to the seismic full waveform inversion method of FIG. 5, input data (recorded/observed real seismic data or d_{obs}) is stored and/or processed on a computing device in operation 505. For example, the seismic data recording sensors 105 in FIGS. 1 and 2 and/or the well log data recording sensors of the well logging tool 315 in FIG. 3 may detect the seismic data and transmit the seismic data to the high-performance computing system shown in FIG. 4. As discussed above in FIGS. 1-4, the seismic data detected in the survey region may be stored in one or more memories such as one or more storage devices 410 and one or more output storage devices 420.

Further, an initial earth model m₀ may be input as the starting point for the seismic full waveform inversion method as shown in FIG. 5. The initial earth model m₀ may be a P-wave velocity model.

This initial velocity model m₀ may be a predetermined velocity model based on conventional seismic tomography. This initial velocity model m₀ may be input by a user through a user interface such as the user interface of the personal computer 425 or may be stored in one or more memories such as one or more storage devices 410 and one or more output storage devices 420.

As shown in the seismic full waveform inversion method of FIG. 5, there is an initial model such as initial velocity model m₀, which is input into a loop. In operation 500, the current velocity model mᵢ is determined. Initially, velocity model mᵢ is the initial velocity model m₀. The variable i denotes an iteration number for the loop. Accordingly, the value of i is zero for the initial computation, i.e., the initial velocity model is m₀. In each iteration in FIG. 5, velocity model mᵢ₊₁ is updated in operation 555. For example, after the first iteration, the velocity model is m₁ with i=0. After the second iteration, the velocity model is m₂ with i=1. Iterations continue until a convergence is detected in operation 560. After convergence is detected in operation 560, the final velocity model mᵢ₊₁ denoted by reference numeral 570, which corresponds to the most recent velocity in operation 555, is output to a storage device or a display. The convergence can be deemed accomplished after completing a predetermined number of iterations, e,g, 20, 50, or 100 iterations, or after the misfit reaches or is lower than a predetermined value.

Referring to operation 500 in the seismic full waveform inversion method of FIG. 5, the velocity model mᵢ is input into operation 510 for forward modeling. Forward modelling of seismic data is a technique that creates (generates) synthetic seismic data d_{syn} from geological information, which in this case is the velocity model mᵢ. Synthetic data d_{syn} is denoted by reference numeral 515 and represents synthetic data output by the forward modeling operation 510.

With input data (recorded seismic data d_{obs}) as referred in 505 and synthetic data d_{syn} as denoted by 515, the conventional FWI is formulated with least-squares (L2) of waveform/data differences as the following:

$$f = {\sum }_{s = 1}^{{N}_{s}} {\sum }_{r = 1}^{{N}_{r}} {\int }_{0}^{{t}_{max}} dt {\vert {d}_{o b s} ( s , r , t ) - {d}_{s y n} ( s , r , t ) \vert}^{2} , \qquad ( 1 )$$

where f denotes the L2 misfit of the waveform differences between the synthetic data and the recorded data, while the modulus operation is denoted by the symbol |·|. Inside the misfit function, Nₛ is the number of sources, Nᵣ is the number of receivers for a given source, tₘₐₓ is the maximum recording time starting from 0, d_{obs}(s, r, t) is the recorded data at time t for a given source s at the receiver r, d_{syn}(s, r, t) is the synthetic data at time t for the same source s and at the same receiver r that is simulated with the current velocity model. This conventional FWI method faces two well-known problems of cycle skipping and amplitude discrepancies that can result in wrong velocity updates, as previously discussed.

FIG. 5 illustrates new FWI methods based on local traveltime differences between the synthetic data and recorded data. The traveltime differences in 520 is obtained by automatically picking by comparing synthetic and recorded data on sliding local windows. Then, traveltime based FWI is formulated as the least-squares (L2) minimization of traveltime differences as below:

$$f = {\sum }_{s = 1}^{{N}_{s}} {\sum }_{r = 1}^{{N}_{r}} {\sum }_{k = 1}^{{N}_{k}} Δ {T}^{2} ( s , r , k ) \qquad ( 2 )$$

as referred to 525 in FIG. 5, where Nₖ means the number of sliding local windows along time axis and k represents local window index. In the following texts, ΔT is used to compactly denote the picked traveltime difference on a local window.

Related to the misfit function, adjoint sources can be obtained in 530. Adjoint of the forward modeling equation is solved to backward propagate the adjoint source to produce backward wavefields as denoted in 535. The backward wavefield can be cross-correlated with the stored forward wavefield in 540 to form the gradient as shown in 545. More specifically, once a gradient is calculated and output by operation 545, a search direction Pᵢ can be calculated using methods such as steepest descent algorithm, a nonlinear conjugate gradient method, or a L-BFGS method. In operation 550, an analytical step length aᵢ is calculated based on the misfit type. Then, the model at iteration i+1 is updated as

$${m}_{i + 1} = {m}_{k} + {a}_{i} {P}_{i} i = 0 , 1 , … , \qquad ( 3 )$$

as indicated in 555.

Referring to the convergence operation 560, the seismic full waveform inversion method determines whether an additional iteration is required. If an additional iteration is required, the numerical value of i is increased in operation 565 and the update velocity model mᵢ₊₁ becomes the velocity model mᵢ in operation 500. Once the inversion is considered to have converged and the final velocity model, i.e. the last updated velocity model mᵢ₊₁ determined in operation 555, is output in 570.

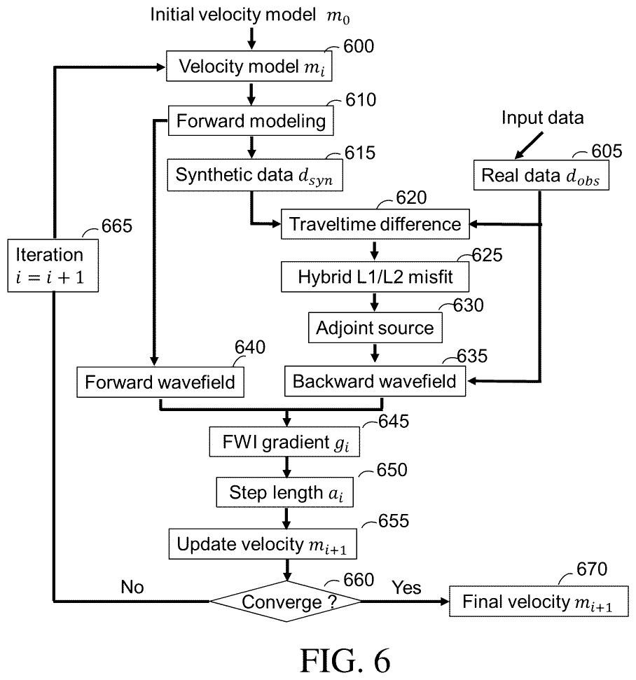

FIG. 6 is a workflow of another embodiment in this disclosure, which depicts a FWI method with hybrid L1/L2 misfit of traveltime differences. Differing from the method shown in FIG. 5, operation 625 utilizes the hybrid L1/L2 norm of traveltime differences and can be mathematically expressed in equation (4):

$$f = {\sum }_{s = 1}^{{N}_{s}} {\sum }_{r = 1}^{{N}_{r}} {\sum }_{k = 1}^{{N}_{k}} ( {( 1 + \frac{Δ {T}^{2}}{{ϵ}^{2}} )}^{\frac{1}{2}} - 1 ) , \qquad ( 4 )$$

which introduces an auxiliary operator of e automatically defined inside the computer codes according to the wavelength period. This method reduces the weight of large traveltime differences that are more likely wrongly picked and gives more weight to relatively small traveltime differences during each FWI iteration for more stable inversion. As a comparison, r in the L1 norm might also reduce the wrong-picking effect of large traveltime differences. However, in L1 norm the first derivative is not continuous, resulting in low inversion convergence.

Related to the misfit difference in equation 4, the adjoint source in 630 and the step length in 650 is different from those in 530 and 550, respectively. The adjoint sources in 630 is described in equation 5 below:

$${d}_{adj} ( s , r , t ) = {\sum }_{k = 1}^{{N}_{k}} \frac{Δ T}{{ϵ}^{2} \sqrt{1 + \frac{Δ {T}^{2}}{{ϵ}^{2}}}} \times \frac{\partial {d}_{o b s} ( s , r , k ; t + Δ T}{\partial t} , \qquad ( 5 )$$

and the step length in 650 can be analytically determined as following:

$$α = \frac{{\sum }_{s = 1}^{{N}_{s}} {\sum }_{r = 1}^{{N}_{r}} {\sum }_{k = 1}^{{N}_{k}} \frac{δ t \times Δ T}{\sqrt{1 + \frac{Δ {T}^{2}}{{ϵ}^{2}}}}}{{\sum }_{s = 1}^{{N}_{s}} {\sum }_{r = 1}^{{N}_{r}} {\sum }_{k = 1}^{{N}_{k}} ( \frac{δ t \times δ t}{\sqrt{1 + \frac{Δ {T}^{2}}{{ϵ}^{2}}}} - \frac{{( δ t \times Δ T )}^{2}}{{ϵ}^{2} \times {( \sqrt{1 + \frac{Δ {T}^{2}}{{ϵ}^{2}}} )}^{3}}} , \qquad ( 6 )$$

where δt denotes the reference traveltime difference by perturbating the current velocity model. The step length determines the updating magnitude of the search direction as shown in equation 3.

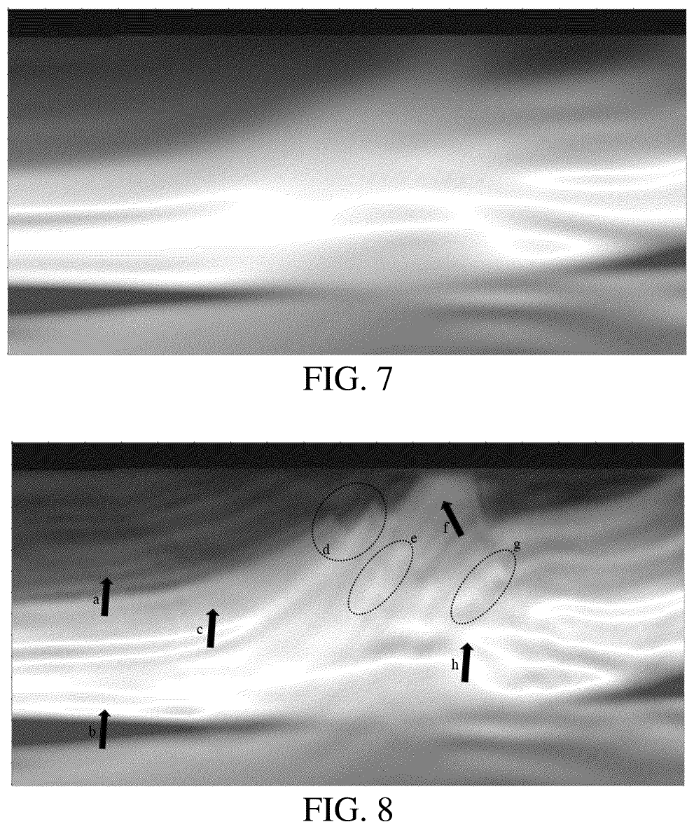

FIGS. 7-11 shows results of FWI with different objective functions of traveltime differences. FIG. 7 shows the initial velocity model with a grid space of 50 m. The bandpass filtered 2.5 Hz data are used, assuming the effective lowest frequency is 2.5 Hz and lower frequencies are not available in the observed data. FIG. 7 is of a low resolution, indicating that traveltime FWI methods can work using the initial velocity model and data frequency but may suffer from cycle skipping.

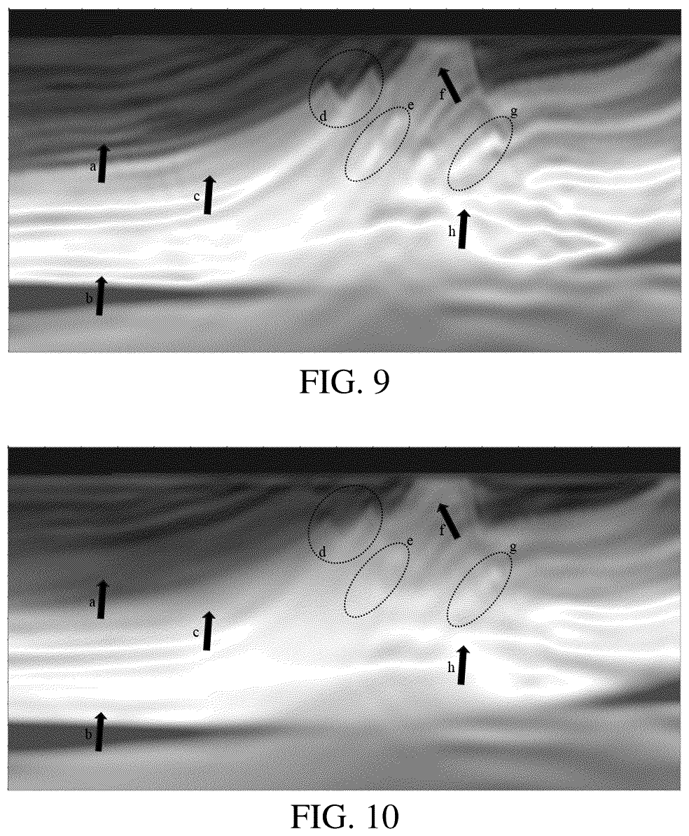

FIG. 8 shows the inverted velocity model using the conventional L2 traveltime mifit based FWI method. FIG. 9 shows the inverted velocity model using the invented hybrid L1/L2 traveltime mifit based FWI method. FIG. 10 shows the inverted velocity model using the L1 traveltime mifit based FWI method. As highlighted by arrows and dashed ellipses on the graph, FIG. 9 provides best velocity resolution and details amongst FIGS. 7-10. For example, the arrows a, b, and c in FIG. 9 point to sedimental layers with more separated events than those in the same areas in FIG. 8 or FIG. 10. Likewise, ellipses d, e, and g and the arrow f in FIG. 9 show geological faults with best distinguishable boundaries or most highlighted features; and the arrow h in FIG. 9 shows the best resolution of geological pinch-outs with most delineated features. FIG. 8 has a higher resolution than FIG. 10, while FIG. 10 has a better resolution than FIG. 7.

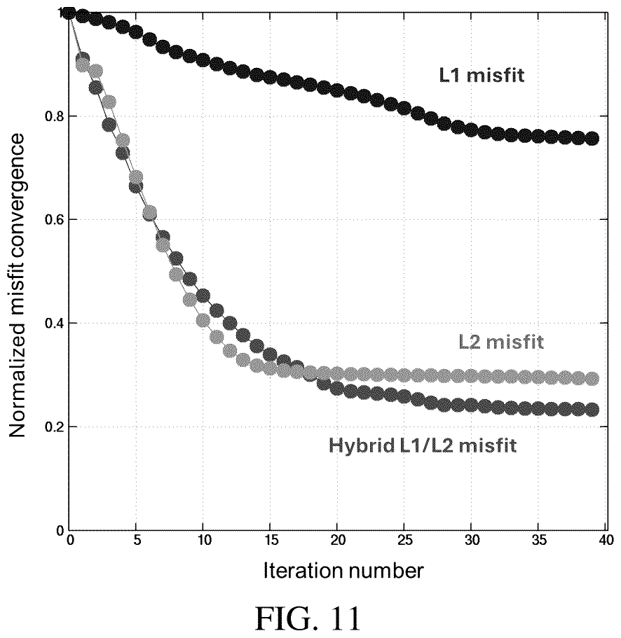

FIG. 11 shows the convergence comparison of the three traveltime FWI methods. The conventional L2 traveltime FWI process is dominated by large traveltime differences and is not able to invert enough velocity details, while the L1 traveltime FWI process converges much slowly. In comparison, the hybrid L1/L2 traveltime FWI process has the best convergence eventually and invert more velocity details.

Embodiments of the present disclosure have been described in detail. Other embodiments will become apparent to those skilled in the art from consideration and practice of the present disclosure. Accordingly, it is intended that the specification and the drawings be considered as exemplary and explanatory only, with the true scope of the present disclosure being set forth in the following claims.

We claim:

1. A method for performing a seismic full waveform inversion to generate a velocity model of subsurface earth structure of a survey region, including:
(a) positioning a plurality of seismic data recording sensors in the survey region and in a well logging tool and lowering the well logging tool into a wellbore in the survey region;
(b) generate seismic waves at one or more points of incidence in the survey region, wherein the seismic waves travel through subsurface earth structure;
(c) observing the seismic waves and recording observed seismic data based on the seismic waves using the plurality of seismic data recording sensors;
(d) transmitting the observed seismic data from the seismic data recording sensors to a computer system having one or more memories and storing the observed seismic data in one or more memories, storing a current velocity model in the one or more memories;
(e) performing, by the computer system, a forward modeling operation and the current velocity model to obtain a forward subsurface wavefield and generate synthetic data;
(f) processing, by the computer system, the synthetic data and the observed seismic data to pick traveltime differences therebetween;
(g) measuring, by the computer system, a difference of the synthetic and observed seismic data with a misfit of traveltime differences;
(h) solving, by the computer system, an adjoint source based on the misfit and the observed seismic data;
(i) obtaining, by the computer system, the backward wavefield with the adjoint sources;
(j) calculating, by the computer system, the gradient with the forward and backward subsurface wavefield, and a search direction;
(k) updating, by the computer system, an iterative step length and the velocity model;
(l) performing operations (e) to (k) until convergence;
(m) outputting the updated velocity model as the final velocity model; and
(n) displaying an image of the final velocity model on a display of the computer system.

2. The method of claim 1, further comprising picking traveltime differences, by the computer system, on sliding local windows of the synthetic data and the observed seismic data.

3. The method of claim 2, further comprising constructing, by the computer system, a hybrid L1/L2 objective function of traveltime differences.

4. The method of claim 3, where the adjoint source is determined based on the hybrid L1/L2 misfit of traveltime differences.

5. The method of claim 1, wherein operation (j) comprises calculating the search direction based on an optimization method according to a steepest descent algorithm, a nonlinear conjugate gradient method, or a L-BFGS method.

6. The method of claim 1, wherein operation (g) further comprises, by the computer system, determining the analytical step length based on the hybrid L1/L2 objective function of traveltime differences.

7. The method of claim 6, wherein operation (k) further comprises, by the computer system, producing an updated velocity model by multiplying the analytical step length with the search direction and adding to the current velocity model.

8. The method of claim 1, wherein the convergence is obtained when a value of the hybrid L1/L2 traveltime difference function is less than a predetermined value.

9. The method of claim 1, wherein the convergence is obtained when the number of iterations reaches a predetermined value.

10. A system for performing a seismic full waveform inversion to generate a velocity model of the subterranean formation of a survey region, the system comprising:
a plurality of seismic data recording sensors positioned in the survey region at different locations and/or a well logging tool including seismic data recording sensors positioned in a well bore in the survey region;
a blasting device positioned at each point of incidence in the survey region to generate seismic waves, which travel through subsurface earth formations; and
a plurality of seismic data recording sensors to sense seismic waves and record seismic data based on the seismic waves;
wherein the seismic data recording sensors transmit the seismic data to a computer system including one or more memories and at least one processor, the one or memories store the transmitted seismic data, a source wavelet, and instructions, and the one or more processors execute the instructions stored in the one or more memories to implement:
performing a forward modeling operation using the source wavelet and a current medium parameter model according to a forward-wave equation and obtain a forward wavefield;
processing the synthetic data and the observed seismic data to Hann window operation, respectively, to obtain a localized synthetic data and a localized seismic data;
selecting a traveltime difference based on a cross-correlation between the localized synthetic data and the localized seismic data;
solving an adjoint equation of the forward wave-equation is solved using the traveltime difference and the localized seismic data to obtain an adjoint source; and
generating an updated medium parameter model for the seismic full waveform inversion and synthetic data using the forward modeling operation.
